(19) United States
(12) Patent Application Publication
(10) Pub. No.: US 2015/0138835 A1
(43) Pub. Date: May 21, 2015

(54) LIGHT GUIDE PLATE, METHOD FOR MAKING THE SAME, BACKLIGHT MODULE, AND DISPLAY DEVICE

(71) Applicants: BOE TECHNOLOGY GROUP CO., LTD., BEIJING (CN); BEIJING BOE OPTOELECTRONICS TECHNOLOGY CO., LTD., BEIJING (CN)

(72) Inventors: Tae Sung Kang, Beijing (CN); Young Man Kwon, Beijing (CN)

(21) Appl. No.: 14/361,181

(22) PCT Filed: Dec. 16, 2013
(86) PCT No.: PCT/CN2013/089472

§ 371 Date: May 28, 2014

(30) Foreign Application Priority Data
Aug. 27, 2013 (CN) 201310378458.6

(51) Int. Cl. F21V 8/00; B29C 45/16

(52) U.S. Cl. CPC G02B 6/0018; G02B 6/0016; G02B 6/0065; B29C 45/1635; B29L 2011/0075
USPC 362/612; 362/623; 362/611; 264/1.24

(57) ABSTRACT

Embodiments of the invention provide a light guide plate comprising a light guide layer and a reflective layer; a lower surface of the light guide being a reflective surface; an upper surface of the light guide layer being a stepped surface and comprising an upper step surface, a lower step surface and an inclined surface connecting the upper step surface and the lower step surface; wherein the lower step surface is a light exiting surface and the reflective surface is coated on the inclined surface. Embodiments of the invention further provide a method for manufacturing the light guide plate, a backlight module provided with such a light guide plate, and a display device provided with such a backlight module.

### TECHNICAL FIELD

Embodiments of the present invention relate to a technique field of display, and more particularly relate to a light guide plate and a method for making the light guide plate, a backlight module provided with such a light guide plate and a display device provide with such a backlight module.

### BACKGROUND

With unceasing development of display technology, thin film transistor liquid crystal displays dominate the field of flat-panel displays due to small dimensions, low power consumption, no radiation and the like. A backlight module is a key component for a liquid crystal display and is used for providing the liquid crystal display with a uniform area light source.

Currently, the liquid crystal displays on cell phones, tablet PCs and the like are getting thinner and thinner, and thicknesses of backlight modules in the liquid crystal displays are continuously reduced accordingly. The backlight modules mainly comprise a light guide plate and a light source disposed at a side of the light guide plate. Light emitting diodes (LED) are mostly used as light sources. As the LED is usually of 0.6 T or 0.4 T (that is, 0.6 mm or 0.4 mm) and cannot have a very small thickness, the current light guide plate is made into a shape of wedge. That is, the upper surface of the light guide plate is a stepped-surface, wherein a portion outside of the display region is thicker and adjacent to the LED, and the greater thickness is used to match a size of the LED, while a portion corresponding to the display region is thinner so as to reduce thickness of the backlight module.

In conventional techniques, the upper surface of the light guide plate is a stepped-surface, and the higher up-step surface and the lower down-step surface are connected through an inclined plane. The inventor found that, in such a configuration, light goes from the light source into the light guide plate, and tends to exit the light guide plate from the inclined plane, thus causing light loss. The light loss not only decreases brilliance of the backlight module but also causes light leakage occur to the liquid crystal display, thus, affecting the display effect.

### SUMMARY

Embodiments of the invention provide a light guide plate, a method for making the light guide plate, a backlight module provided with such a light guide plate, and a display device provided with such a backlight module, so as to solve the technical problems of conventional wedge-shaped light guide plates, producing loss of light and reducing brilliance of the backlight module and light leakage of the liquid crystal display, which affect display effect.

In order to achieve the purpose mentioned above, embodiments of the invention provide a light guide plate comprising a light guide layer and a reflective layer; wherein

a lower surface of the light guide layer being reflective and an upper surface of the light guide layer being a stepped surface which comprises an upper step surface, a lower step surface and an inclined surface connecting the upper step surface and the lower step surface, and

wherein the lower step surface is a illuminating surface and the reflective layer is coated on the inclined surface.

Further, the reflective layer is coated on the inclined surface and the upper step surface.

Material for the reflective layer is a resin having a property of reflecting light.

The light guide layer and the reflective layer are formed by an injection molding process.

Further, the reflective surface has a plurality of concave or convex reflective structures.

Embodiments of the invention further provide a backlight module comprising a light source and the light guide plate as described above, the light source is arranged at a side surface adjacent to the upper step surface of the light guide layer.

The light source is a LED.

Further, a reflective plate is further disposed under the light guide plate, and a diffusion plate and at least one prism plate are further disposed above the light guide plate.

Embodiments of the invention further provide a display device comprising the backlight module as described above.

Embodiments of the invention further provide a method for manufacturing the light guide plate as described above, in which the light guide plate is manufactured by means of an injection molding mold, the injection molding mold comprising a fixed die, a moving die, a first injector and a second injector, the method comprising:

moving the moving die so as to form a first cavity between the moving die and the fixed die;

forming a first layer in the first cavity by means of the first injector;

moving the moving die so as to form a second cavity between the first layer and the fixed die;

forming a second layer in the second cavity by means of the second injector;

wherein the first layer and the second layer are a light guide layer and a reflective layer, respectively, or the first layer and the second layer are a reflective layer and a light guide layer, respectively.

In one implementation of the invention, the fixed die is provided with a first groove and a second groove;

moving the moving die so as to form the first cavity between the moving die and the fixed die comprising moving the moving die so as to form the first cavity between the moving and the first groove of the fixed die;

moving the moving die so as to form the second cavity between the first layer and the fixed die comprising moving the moving die as so as form the second cavity between the first layer and the second groove of the fixed die.

In another implementation of the invention, the moving die is a slidable pusher;

moving the moving die so as to form the first cavity between the moving die and the fixed die comprising sliding the moving die so as to make the moving die separate the fixed die into the first cavity and the second cavity;

moving the moving die so as to form a second cavity between the first layer and the fixed die comprising sliding the moving die so as to form a second cavity between the first layer and the fixed die.

With respect to conventional techniques, the technical solutions as provided by embodiments of the invention have the following advantages. The light guide plate according to embodiments of the invention has a light guide layer, an upper surface of the light guide layer is a stepped surface and constitutes of an upper step surface, an inclined surface and a lower step surface, i.e., the light guide layer being wedge-shaped, and the inclined surface of the light guide layer is coated by a reflective layer. Upon light being incident on the inclined surface, the reflective layer can prevent the light from emitting from the light guide layer and reflect the light back inside the light guide layer and make the light finally exit the light guide layer from a light exiting surface (the lower step surface). Thus, loss of light can be reduced effectively and brilliance of the backlight module is improved. And moreover, light leakage impacting the display effect in the liquid crystal display is avoided.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic view of a light guide plate according to a first embodiment of the invention;

FIG. 2 is a schematic view of a light path in the light guide plate according to the first embodiment of the invention;

FIG. 3 is a schematic view of a light guide plate according to a second embodiment of the invention;

FIG. 4 is a schematic view of a backlight module according a third embodiment of the invention;

FIG. 5 is a schematic view of an injection molding mold used in a method for manufacturing a light guide plate according to a fifth embodiment of the invention; and

FIG. 6 is a schematic view of an injection molding mold used in a method for manufacturing a light guide plate according to a sixth embodiment of the invention.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

### First Embodiment

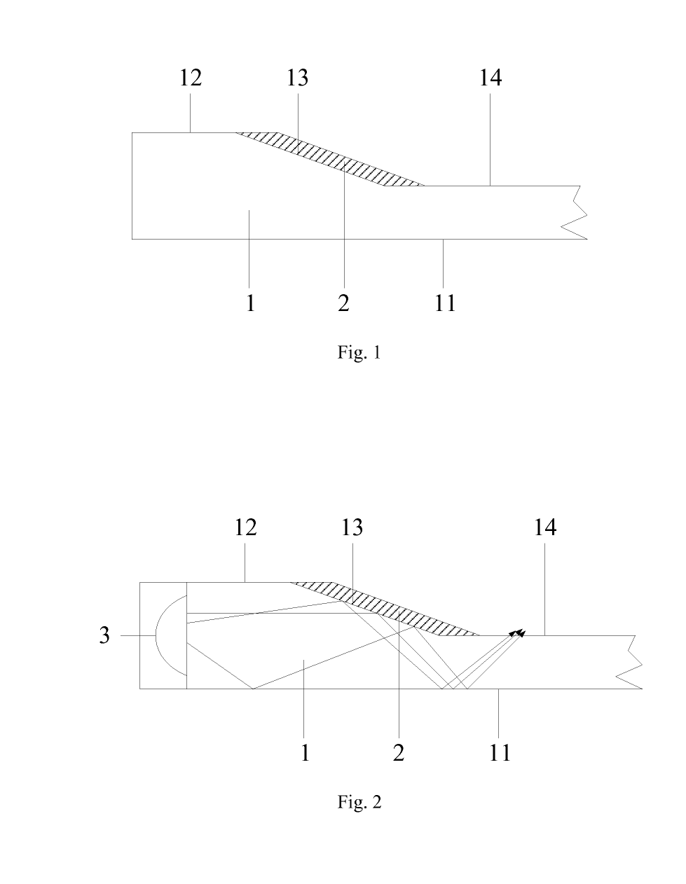

As illustrated in FIG. 1, a light guide plate according to an embodiment of the invention comprises a light guide layer 1 and a reflective layer 2. The lower surface 11 of the light guide layer 1 is a reflective surface, which usually comprises a plurality of convex or concave reflective structures (not shown). The upper surface of the light guide layer 1 is a stepped surface, comprising an upper step surface 12, a lower step surface 14 and an inclined surface 13 connecting the upper step surface 12 and the lower step surface 14. In this embodiment, the lower step surface 14 is a light exiting surface and corresponds to a display region. The upper step surface 12 and the inclined surface 13 are outside of the display region, that is, a portion of the light guide layer 1 outside of the display region is a shape of wedge. A reflective layer 2 is coated on the inclined surface 13, and is made of a resin with a reflection property. In other implementations of the invention, the reflective layer can also be made of a metal with good reflection property. With respect to metal, resin is of low cost and can be formed together with the light guide layer by means of an injection molding process. Thus, the manufacturing process is further simpler.

The light guide layer 1 of the light guide plate according to this embodiment of the invention is in a shape of wedge. The upper surface of the light guide layer 1 is a stepped surface and constitutes of an upper step surface 12, an inclined surface 13 and a lower step surface 14, wherein the inclined surface 13 is coated by a reflective layer 2. As illustrated in FIG. 2, if light emitted from the light source 3 is incident on the inclined surface 13, or is incident on the inclined surface 13 after being reflected, the reflective layer 2 can prevent the light from exiting the light guide layer 1, and reflect the light back inside the light guide layer 1. The light will be reflected once or more than one time inside the light guide layer 1 and exit the light exiting surface (i.e., the lower step surface 14) finally. Thus, light loss is reduced effectively and brilliance of the backlight module is improved. And moreover, the problem that light leakage from the inclined surface 13 outside of the display region of a liquid crystal display affects display effect will be avoided.

Further, as the reflective layer 2 of the inclined surface 13 can prevent light leakage, the length and the slope of the inclined surface 13 can be increased so as to increase difference in height between the upper step surface 12 and the lower step surface 14, such that a portion where the lower step surface 14 (i.e., the light exiting surface) is located is thinner, that is, a portion of the light guide layer 1 in the display region is reduced in thickness. Thus, a thickness of the backlight module is further reduced.

In this embodiment, the light guide layer and the reflective layer are formed by a means of an injection molding process. The injection molding process is simple and reliable, the light guide plate can be manufactured by the injection molding process with a high productivity. And moreover, the light guide layer can be made very thin by means of the injection molding process, and the thickness of the light guide plate will not be affected.

### Second Embodiment

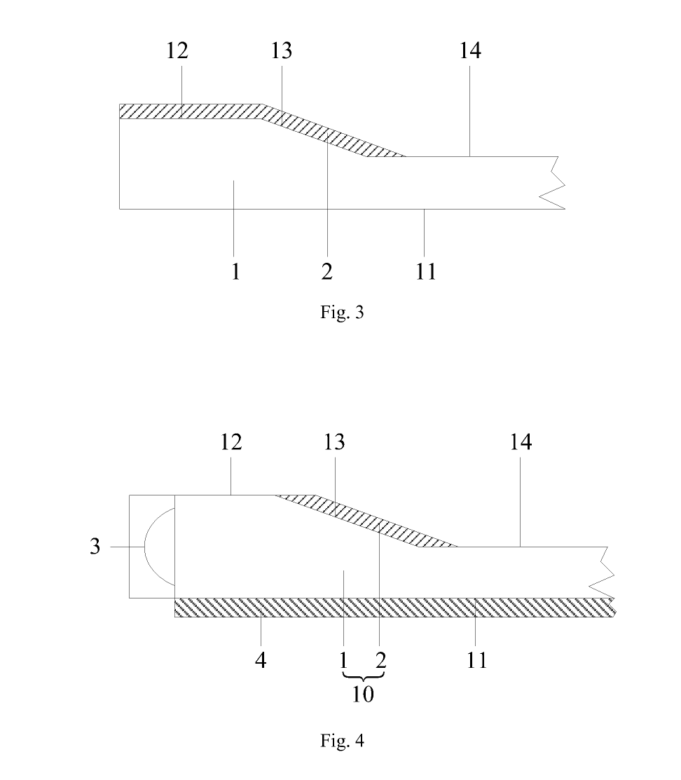

As illustrated in FIG. 3, the difference between the second embodiment and the first embodiment lies in that, as illustrated in FIG. 3, a reflective layer 2 is coated on the inclined surface 13 and the upper step surface 12. So, the reflective layer 2 not only covers the inclined surface 13 but also the upper step surface 12. Thus, the reflective layer 12 can further prevent light from exiting the light guide layer 1 from the upper step surface 12, such that light loss is further reduced and brilliance of the backlight module is further improved.

### Third Embodiment

According to another aspect of the invention, a backlight module is provided, comprising a light source 3 and a light guide plate 10 according to the first or second embodiment of the invention. The light source 3 is a light emitting diode (LED), and disposed at a side surface adjacent to the upper step surface 12 of the light guide layer 1.

Further, a reflective plate 4 is further disposed under the light guide plate 10, and a diffusion plate (not shown) and at least one prism plate (not shown) are disposed above the light guide plate 10.

In the backlight module according to this embodiment of the invention, the light guide layer 1 of the light guide plate 10 is in a shape of wedge, the light guide layer 1 comprises an upper surface that is a stepped surface and constitutes of an upper step surface 12, a lower step surface 14 and an inclined surface 13 connecting the upper step surface 12 and the lower step surface 14. The inclined surface 13 of the light guide layer 1 is coated by a reflective layer 2. If light is incident on the inclined surface 13, the reflective layer 2 can prevent the light form exiting the light guide layer 1 and reflect the light back inside the light guide layer 1. The light will be reflected once or more than one time inside the reflective layer 1, and finally exit from the light exiting surface (the lower step surface 14), so as to reduce light loss effectively. Thus, the backlight module according to this embodiment of the invention has a higher brilliance and removes the problem that light leakage, which light exits from the inclined surface 13 and the upper step surface 12 outside the display region of the liquid crystal display, affects the display effect.

Further, as the reflective layer 2 on the inclined surface 13 can prevent light leakage, the length and the slope of the inclined 13 can be increased so as to increase difference in height between the upper step surface 12 and the lower step surface 14, such that the portion where the lower step surface 14 is located is made thinner. That is, the portion of the light guide layer 1 in the display region is reduced in thickness such that the backlight module according to embodiments of the invention is further reduced in thickness.

### Fourth Embodiment

According to yet another aspect of the invention, a display panel is provided, comprising the backlight module according to the embodiments as described. The display device can be any product or component that has a display function, such as a liquid crystal panel, a liquid crystal TV, a liquid crystal display, a digital frame, a cell phone, a tablet PC, and the like.

As the display device according to embodiments of the invention and the backlight module and the light guide plate according embodiments of the invention have common technical features, so, it can produce the same technical effect and solve the same technical problem.

### Fifth Embodiment

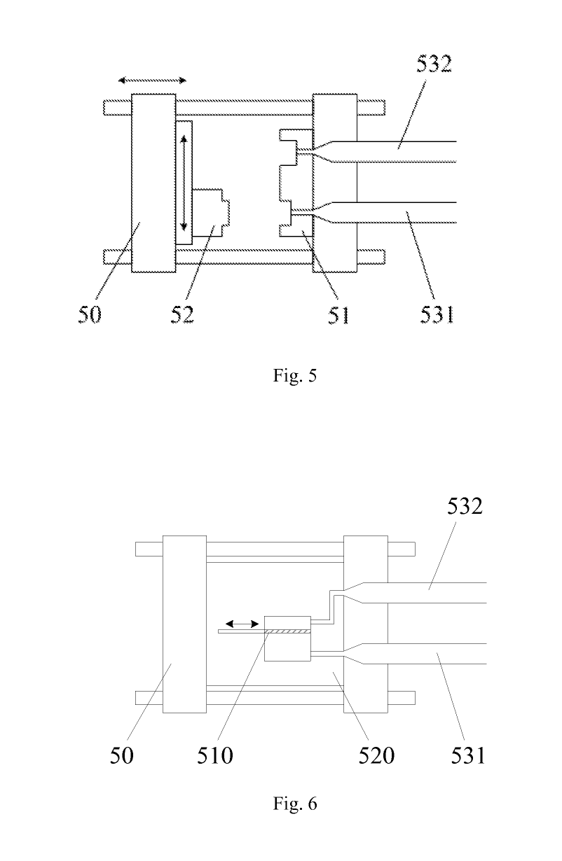

According to still another aspect of the invention, a method for manufacturing the light guide plate according to the first and second embodiment is provided. The method manufactures a light guide plate by means of an injection molding mold, which comprises a fixed die 51, a moving die 52, a first injector 531 and a second injector 532, as illustrated in FIG. 5.

The method for manufacturing the light guide plate comprising the following steps:

Step S1, moving the moving die so as to form a first cavity between the moving die and the fixed die.

As illustrated in FIG. 5, the moving die 52 is fixed on a base 50 of the injection molding mold, and is driven to the right side by the base 50 such that the moving die 52 is matched with a first groove at a lower position of the fixed die 51 so as to form a first cavity.

Step S2, forming a first layer in the first cavity by means of the first injector.

After the first cavity is formed, a liquid material can be injected into the first cavity be means of the first injector 531 so as to form a first layer in the first cavity. During manufacturing the light guide plate, a light guide layer can be formed firstly or a reflective layer can be formed firstly. The embodiment is described by taking a case that a light guide layer (i.e., the first layer being a light guide layer) is firstly formed as an example.

Further, the surface of the moving die 52 has concave or convex structures such that a plurality of convex or concave structures can be formed on the lower surface of the light guide layer when forming the light guide layer.

Step S3, moving the moving die 52 so as to form a second cavity between the first layer and the fixed die.

After the light guide layer is formed, the base 50 moves the moving die 52 to the left side, the light guide layer being moved together with the moving die 52.

And then the moving die 52 is rotated by an angle of 180°. On the basis of the actual configuration of the injection molding mold, the moving die 52 can be rotated by the base 50 together with the base 50, or the moving die 52 can be rotated independently while the base 50 is stationary.

After the moving die 52 being rotated by 180°, the moving die 52 is moved to the right side together with the light guide layer by the base 50, such that the light guide layer is matched with a second groove at an upper position of the fixed die 51 so as to form a second cavity.

Step S4, forming a second layer in the second cavity by means of a second injector 532.

After the second cavity is formed, a resin material with reflection property is injected into the second cavity by means of a second injector 532 so as to form a second layer, i.e., a reflective layer, in the second cavity.

The light guide plate according to the first or second embodiment of the invention can be formed by performing steps S1 to S4.

In other implementations, a reflective layer can also be formed in the first cavity and then a light guide layer can be formed in the second cavity. Then, a surface of the groove at the upper position of the fixed die should have concave and convex structures such that a plurality of convex or concave reflective structures can be formed on the lower surface of the light guide layer while forming the light guide layer in the second cavity.

### Sixth Embodiment

This embodiment of the invention provides a method for manufacturing the light guide plate according to the first and second embodiments. This embodiment is basically same as the fifth embodiment, and the difference therebetween lies in the following. As illustrated in FIG. 6, a fixed die 510 in the embodiment has a bigger cavity itself, and the moving die 520 is a slidable pusher. When the moving die 520 is slid to the right end, the fixed die 510 is separated into a first cavity and a second cavity. A first layer can be formed in the first cavity by means of the first injector 531. And then, the moving die 520 is slid to the left end, and a second cavity is formed between the first layer and the fixed die 510. After that, a second layer is formed in the second cavity by means of the second injector 532. Thus, a light guide plate according to the first or second embodiment of the invention can be formed.

The foregoing are merely exemplary embodiments of the invention, but are not used to limit the protection scope of the invention. The protection scope of the invention shall be defined by the attached claims.

1. A light guide plate, comprising
a light guide layer and a reflective layer;
a lower surface of the light guide being a reflective surface;
an upper surface of the light guide layer being a stepped surface and comprising an upper step surface, a lower step surface and an inclined surface connecting the upper step surface and the lower step surface;
wherein the lower step surface is a light exiting surface and the reflective surface is coated on the inclined surface.

2. The light guide plate according to claim 1, wherein the reflective layer is coated on the inclined surface and the upper step surface.

3. The light guide plate according to claim 1, wherein the reflective layer is made of a resin material with a reflection property.

4. The light guide plate according to claim 1, wherein both the light guide layer and the reflective layer are formed by an injection molding process.

5. The light guide plate according to claim 1, wherein the reflective surface has a plurality of concave or convex reflective structures.

6. A backlight module, comprising a light source and the light guide plate according to claim 1, wherein the light source is disposed at a side adjacent to the upper step surface of the light guide layer.

7. The backlight module according to claim 6, wherein the light source is a light emitting diode.

8. The backlight module according to claim 6, wherein a reflective plate is further disposed below the light guide plate, and a diffusion plate and at least one prism plate are further disposed above the light guide plate.

9. A display device comprising the backlight module according to claim 6.

10. A method for manufacturing the light guide plate according to claim 1, wherein the light guide plate is manufactured by an injection molding mold which comprises a fixed die, a moving die, a first injector and a second injector, the method comprising:
moving the moving die so as to form a first cavity between the moving die and the fixed die;
forming a first layer in the first cavity by means of the first injector;
moving the moving die so as to form a second cavity between the first layer and the fixed die;
forming a second layer in the second cavity by means of the second injector;
wherein the first layer and the second layer are a light guide layer and a reflective layer, respectively, or the first layer and the second layer are a reflective layer and a light guide layer, respectively.

11. The method according to claim 10, wherein
the fixed die is provided with a first groove and a second groove;
the first cavity is formed between the moving die and the first groove of the fixed die by moving the moving die; and
the second cavity is formed between the first layer and the second groove of the fixed die by moving the moving die.

12. The method according to claim 10, wherein the moving die is a slidable pusher; the fixed die is separated into the first cavity and the second cavity through the moving die by sliding the moving die; and the second cavity is formed between the first layer and the fixed die by sliding the moving die.

13. The light guide plate according to claim 2, wherein the reflective layer is made of a resin material with a reflection property.

14. The light guide plate according to claim 2, wherein both the light guide layer and the reflective layer are formed by an injection molding process.

15. The light guide plate according to claim 3, wherein both the light guide layer and the reflective layer are formed by an injection molding process.

16. The light guide plate according to claim 2, wherein the reflective surface has a plurality of concave or convex reflective structures.

17. The light guide plate according to claim 3, wherein the reflective surface has a plurality of concave or convex reflective structures.

18. The light guide plate according to claim 4, wherein the reflective surface has a plurality of concave or convex reflective structures.

19. A backlight module, comprising a light source and the light guide plate according to claim 2, wherein the light source is disposed at a side adjacent to the upper step surface of the light guide layer.

20. A backlight module, comprising a light source and the light guide plate according to claim 5, wherein the light source is disposed at a side adjacent to the upper step surface of the light guide layer.
